(19) United States
(12) Patent Application Publication
(10) Pub. No.: US 2012/0200197 A1
(43) Pub. Date: Aug. 9, 2012

(54) Oscillation Motor and Lens Driving Mechanism

(75) Inventor: Naoto Shiga, Saitama-shi (JP)

(73) Assignee: TAMRON CO., LTD., Saitama-shi (JP)

(21) Appl. No.: 13/333,675

(22) Filed: Dec. 21, 2011

(30) Foreign Application Priority Data
Feb. 3, 2011 (JP) 2011-021962

(51) Int. Cl. H02N 2/00

(52) U.S. Cl. 310/328

(57) ABSTRACT

An oscillation motor is provided in which the influence of vibration on other components by avoiding generation of noise in operation is reduced. The oscillation motor that makes an oscillator vibrate and transmits the vibration generated in the oscillator as a driving force by bringing the oscillator into pressure-contact with a driven body includes a base member; an oscillator that is mounted on the base member and is provided with a protruding output section on one side surface on one end side, the output section is arranged in contact with the driven body; and a press mechanism that is mounted on the base member and presses the oscillator toward the driven body on the other side surface on the opposite end side of the oscillator, wherein an vibration insulating member is provided between the base member and the press mechanism is employed.

### BACKGROUND OF THE INVENTION

1. Field of the Invention

The present invention relates to an oscillation motor that makes an oscillator vibrate and transmits the vibration generated in the oscillator as a driving force by bringing the oscillator into pressure-contact with a driven body, and a lens driving mechanism that makes a lens travel in an optical axis direction by using the oscillation motor.

2. Background Art

Oscillation motors are one of driving sources of various devices having a movable mechanism. The oscillation motor is a device which makes an oscillator provided with an output section vibrate to generate a rotational movement in an elliptical pattern or the like in the output section, and transmit the energy to a driven body by a frictional force between the output section and the driven body by bringing the output section into contact with the driven body. Among the oscillation motors, an ultrasonic motor is suitable for reduction in size and weight because of excellent-torque at low-revolution and excellent silence. Thus, the ultrasonic motors are used as a driving source of a movable mechanism in an auto-focusing function of camera or in a scanning electron microscope or the like which requires precise positioning.

Japanese Patent No. 4182588 discloses an oscillation motor used in an optical system driving device. The present applicant has proposed an oscillation motor unit disclosed in Japanese Patent Laid-Open No. 2010-206907, in which mounting area required for an oscillation motor is reduced and it contributes to size reduction of an optical system driving device. As disclosed in Japanese Patent No. 4182588 and Japanese Patent Laid-Open No. 2010-206907, when the oscillation motor is used in the optical system driving device such as a camera, the oscillation motor and a driving force transmission mechanism are required to be arranged in a limited space. Thus, a small size oscillation motor excellent in driving efficiency has been investigated.

FIG. 4 shows the positional relationship between an oscillator and a driven body in an oscillation motor. As shown in FIG. 4, in the oscillation motor, an output section 101 provided on an oscillator 100 is required to be brought into pressure-contact with a driven body 200 to transmit a rotational movement generated in the output section 101 to the driven body 200. Thus, the oscillation motor comprises a press mechanism that presses the oscillator 100 toward the driven body 200. The press mechanism brings the oscillator 100 into pressure-contact with the driven body 200 by pressing the oscillator 100 from the other side surface 103 on the opposite side from the one side surface 102 having the output section 101. To stably transmit a driving force to the driven body 200, a press force is recommended to be applied from the direction of an arrow in FIG. 4 on the straight line including a contact portion between the driven body 200 and the output section 101.

However, when the oscillation motor is used as a lens driving mechanism, space available for mounting is restricted. Thus, it is difficult to arrange the press mechanism on the same straight line in series with the contact portion between the driven body 200 and the output section 101. To solve the problem, a press force transmission member curved substantially along an outer rim portion of a through hole formed in a base member is used in a press member disclosed in Japanese Patent No. 4182588. A press mechanism disclosed in Japanese Patent Laid-Open No. 2010-206907 employs a mechanism for transmitting a press force of the press mechanism through a press guide by arranging the oscillator on a first surface of a base member and arranging the press mechanism on a second surface.

In the oscillation motor, the vibration generated in the oscillator in operation is recommended to be utilized only to move the output section. However, the vibration is inevitably slightly transmitted to the components equipped around the oscillator through oscillator holding member or the like. When the vibration generated in the oscillator is transmitted to the components equipped around the oscillator, a resonance phenomenon may occur to generate a noise. Since one of the fundamental features of the oscillation motor according to a driving theory is silence in operation, a driving mechanism using the oscillation motor is recommended to be designed with silence. Thus, there is a demand to avoid the noise caused by the resonance phenomenon in the oscillation motor.

The vibration generated in the oscillator in operation is slightly transmitted to the components equipped around the oscillator. As a result, a backlash is generated in the components constituting the oscillation motor, and a function of the press mechanism may be affected in a long time operation of the oscillation motor.

It is thus an object of the present invention to provide an oscillation motor in which the influence of vibration on other components by avoiding generation of noise in operation is reduced.

### BRIEF DESCRIPTION OF THE DRAWINGS

FIG. 1 is a plan view illustrating one embodiment of an oscillation motor according to the present invention;

FIG. 2 includes a cross sectional view cut along a line A-A in FIG. 1;

FIG. 3(A) is a partial plan view illustrating the configuration of a base member and a press mechanism of the oscillation motor shown in FIG. 1; FIG. 3(B) includes a cross sectional view cut along a line C-C in FIG. 3(A); and

FIG. 4 is a schematic view illustrating the positional relationship between an oscillator and a driven body in an oscillation motor.

### SUMMARY OF THE INVENTION

As a result of intense study, the present inventor has achieved the above object by employing an oscillation motor described below.

An oscillation motor according to the present invention is an oscillation motor that makes an oscillator vibrate and transmits the vibration generated in the oscillator as a driving force by bringing the oscillator into pressure-contact with a driven body, comprising: a base member; an oscillator having a protruding output section on an one side surface on one end side and mounted on the base member and the output section is arranged in contact with the driven body; and a press mechanism that is mounted on the base member and presses the oscillator toward the driven body on the other side surface on the opposite end side of the oscillator, wherein an vibration insulating member is provided between the base member and the press mechanism.

In the oscillation motor according to the present invention, the vibration insulating member may be a buffer material composed of one selected from a plastic with excellent softness, a silicon-based member, and a rubber-based member.

In the oscillation motor according to the present invention, the press mechanism may comprise a pressure source and a pressure transmission section that transmits a press force from the pressure source to the oscillator, the pressure transmission section may be mounted on the base member via a support shaft, and the vibration insulating member may be provided between the pressure transmission section and the base member in the vicinity of the pressure source.

In the oscillation motor according to the present invention, the press mechanism may comprise a pressure source and a pressure transmission section that transmits a press force from the pressure source to the oscillator, an end portion of the press mechanism at the pressure source may be mounted on the base member, and the vibration insulating member may be provided between the end portion of the press mechanism at the pressure source and the base member.

A lens driving mechanism according to the present invention comprises the oscillation motor described above as a driving source for making a lens travel in an optical axis direction.

In the oscillation motor according to the present invention, the vibration insulating member is provided between the base member and the press mechanism. Thus, silence in operation can be made significantly excellent. The influence of fine vibration caused by the vibration generated in the oscillator transmitted to the press mechanism through the base member can be avoided, so that the operation of the press mechanism can be maintained in an appropriate state.

### DETAILED DESCRIPTION OF THE PREFERRED EMBODIMENTS

In the following, a preferred embodiment of an oscillation motor and a lens driving mechanism according to the present invention will be demonstrated.

The oscillation motor according to the present invention makes an oscillator vibrate and transmits the vibration generated in the oscillator as a driving force by bringing the oscillator into pressure-contact with a driven body. The oscillation motor comprises the oscillator and a press mechanism mounted on a base member. In the oscillation motor according to the present invention, a vibration insulating member is provided between the base member and the press mechanism.

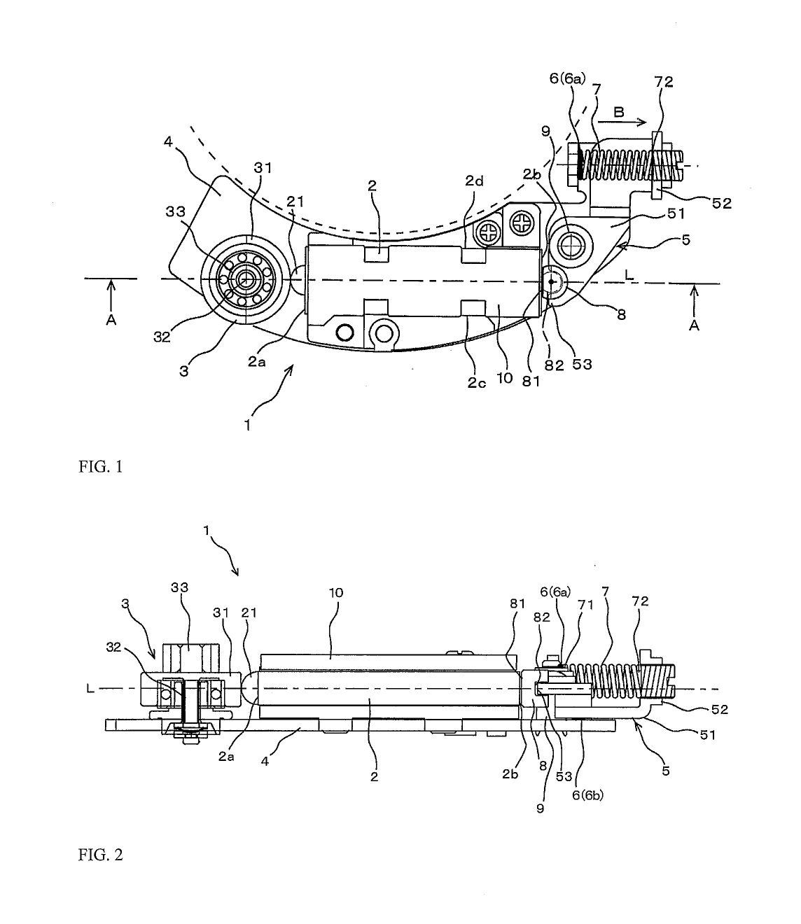

FIG. 1 is a plan view illustrating an example in which the oscillation motor according to the present invention is arranged on the outer peripheral side of an image pickup lens as a driving mechanism for the lens. FIG. 2 includes a cross sectional view cut along a line A-A in FIG. 1. As shown in FIGS. 1 and 2, in an oscillator 2 of an oscillation motor 1, an output section 21 provided on the one side surface 2a on one side is arranged at a position in contact with a driven body 3, and a press mechanism 5 is arranged in contact with the other side surface 2b. The driven body 3 and the press mechanism 5 are respectively mounted on a base member 4, and the oscillator 2 is held in an oscillator holder 10 mounted on the base member 4.

The driven body 3 is a movable member driven due to the movement transmitted from the output section 21 of the oscillator 2. In the example shown in FIGS. 1 and 2, a drive transmission section 31 whose outer shape is substantially cylindrical is mounted on the base member 4 in a rotatable manner around a fixing shaft 32. The output section 21 of the oscillator 2 is in pressure-contact with the drive transmission section 31. When the output section 21 performs a predetermined movement, the drive transmission section 31 is made rotate by a frictional force between the output section 21 and the drive transmission section 31. A driving force output section 33 is made rotate in conjunction with the drive transmission section 31. A lens driving mechanism (not shown) is connected to the driving force output section 33. The oscillation motor 1 thereby acts as a driving source of the lens driving mechanism. Next, the driven body 3 may be an object to be driven which is directly driven by the oscillation motor 1, or may be an intermediate member which transmits the driving force to an object to be driven.

In the present embodiment, an oscillator composed of a piezoelectric element having a shape substantially rectangular solid is used as the oscillator 2. The oscillator 2 has the protruding output section 21 on the one side surface 2a on one end side. The output section 21 is arranged in contact with the driven body 3. In the case of the oscillation motor using the piezoelectric element, an vibration is generated in the piezoelectric element by adjusting the shape of the piezoelectric element, the position to apply a voltage, the level or frequency of applied voltage or the like such that the vibration is converted into a predetermined regular movement in the output section 21. In the present embodiment, an elliptical rotation is generated in the output section 21.

The oscillator holder 10 holds the oscillator 2 in a state in which the oscillator 2 can be made vibrate. The oscillator 2 is held in the oscillator holder 10 in a state in which the one side surface 2a on the output section 21 side and the other side surface 2b are exposed. In the present embodiment, the oscillator 2 is held at a few node positions of the vibration generated in the oscillator 2 on the side surfaces 2c and 2d of a longitudinal direction and top and bottom surfaces of the oscillator 2. As shown in FIG. 1, the oscillator 2 is held in the oscillator holder 10 such that the output section 21 is in contact with an outer peripheral surface of the drive transmission section 31 of the driven body 3 on a virtual straight line L passing through the center of the fixing shaft 32 of the driven body 3. In the present specification, the virtual straight line L passing through the center of the fixing shaft 32 of the driven body 3 is referred to as a reference line L for transmitting the power from the oscillator 2 to the driven body 3.

Next, the press mechanism 5 presses the oscillator 2 toward the driven body 3 on the other side surface 2b of the oscillator 2 on the other end side. The press mechanism 5 comprises a pressure source 7, a pressure transmission section 51, and a pressure correction section 8, and is arranged on the other side surface 2b on the opposite side from the output section 21 of the oscillator 2 as shown in FIGS. 1 and 2. The pressure source 7 is composed of an elastic member such as a coil spring, a rubber, a plate spring or the like. In the present embodiment, the coil spring is used as the pressure source 7, which is arranged at a position apart from the oscillator 2 and where an expansion and contraction direction of the coil spring is parallel to the reference line L. One end portion 71 of the pressure source 7 is fixed to the base member 4, and the other end portion 72 is connected to the pressure transmission section 51.

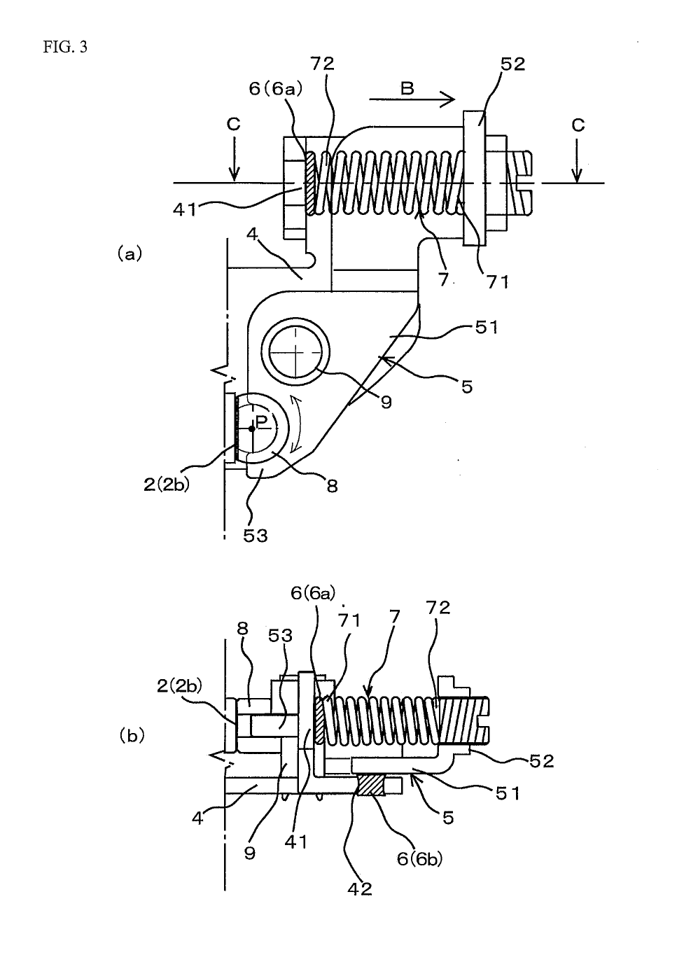

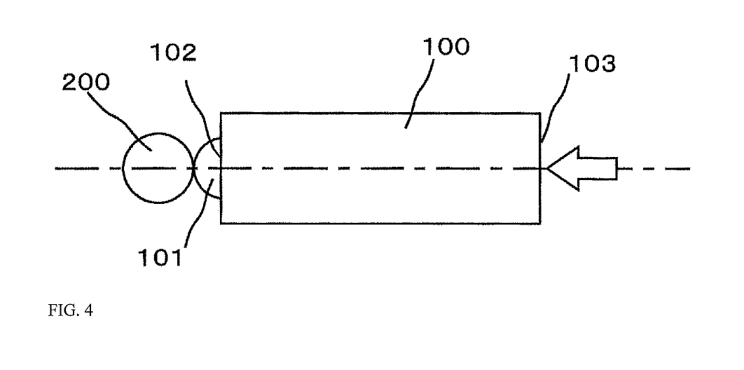

The pressure transmission section 51 of the press mechanism 5 is a member that transmits a press force of the pressure source 7 to the oscillator 2. FIG. 3(A) is a partial plan view illustrating the configuration of the base member 4 and the press mechanism 5 of the oscillation motor 1. FIG. 3(B) includes a sectional view cut along a line C-C in FIG. 3(A). In the present embodiment, the pressure transmission section 51 is an arm-like member mounted on the base member 4 via a support shaft 9 and rotatable about the support shaft 9. The pressure transmission section 51 is connected to the pressure source 7 via a pressure source connection section 52. Accordingly, when a force in the direction of an arrow B is applied to the pressure source connection section 52, the pressure transmission section 51 rotates about the support shaft 9. Then, a force in a direction where an output end portion 53 which outputs the press force approaches to the oscillator 2. As a result, a force to press the oscillator 2 toward the driven body 3 is transmitted to the press mechanism 5.

The press mechanism 5 further includes the pressure correction section 8 rotatably provided at a contact position with the oscillator 2. As shown in FIGS. 1 and 2, the pressure correction section 8 comprises a planar portion 81 in contact with the other side surface 2b of the oscillator 2 on the other end side, and a connection portion 82 rotatably geared with the pressure transmission section 51. The rotatable pressure correction section 8 is provided between the pressure transmission section 51 and the other side surface 2b of the oscillator 2. The pressure correction section 8 can thereby correct the direction of a press force of the pressure transmission section 51 with respect to the other side surface 2b of the oscillator 2 to stably press the oscillator 2 at a predetermined direction.

In the oscillation motor 1 according to the present invention, the vibration insulating member 6 is provided between the press mechanism 5 and the base member 4. By the way, a noise might be generated in the oscillation motor 1 due to the resonance of constituent components of the oscillation motor 1. That is, when the press mechanism 5 presses the oscillator 2 toward the driven body 3 by using an urging force of the pressure source 7, the pressure transmission section 51 (the pressure correction section 8 in the present embodiment) of the press mechanism 5 receives a reaction from the other side surface 2b of the oscillator 2, and the vibration generated in the oscillator 2 may be slightly transmitted to the press mechanism 5 from the oscillator 2. Next, the press mechanism 5 comprises the pressure source 7 having elasticity and the pressure transmission section 51, and is rotatable toward the oscillator 2. Then, components constituting the press mechanism 5 are easily made vibrate due to the slight vibration transmitted from the oscillator 2, to thereby cause the resonance. Thus, the generation of the noise is avoided by arranging the vibration insulating member 6 provided between the press mechanism 5 and the base member 4.

The vibration insulating member 6 is a buffer material composed of one selected from a plastic with excellent softness, a silicon-based member, and a rubber-based member. The vibration insulating member 6 may be provided between the press mechanism 5 and the base member 4. As amore preferred aspect, the vibration insulating member 6 may be provided between the pressure transmission section 51 and the base member 4, and/or between the pressure source 7 and the base member 4 as shown in FIGS. 3.

FIG. 3(A) shows a configuration in which a vibration insulating member 6a is provided between the pressure source 7 constituting the press mechanism 5 and the base member 4. In practice, the one end portion 71 of the coil spring as the pressure source 7 is mounted on a pressure source mounting section 41 which is formed by bending a portion of the base member 4 and in which a gear portion with the coil spring 7 is provided. The vibration insulating member 6a is provided between the one end portion 71 of the coil spring 7 and the pressure source mounting section 41. The vibration insulating member 6a may be provided by bonding the end portion 71 of the coil spring 7 to the pressure source mounting section 41 by using an elastic adhesive which has low viscosity at the time of attaching and maintain elasticity after curing, for example. In addition, the pressure source mounting section 41 may be formed as a concave portion or a convex portion corresponding to the shape of the end portion 71 of the coil spring 7, and the vibration insulating member 6a composed of a ring-shaped elastic member that is fitted such that the end portion 71 of the coil spring 7 and the pressure source mounting section 41 are able to gear with each other may be provided between the end portion 71 of the coil spring 7 and the pressure source mounting section 41 when the concave or convex portion is fitted with the end portion 71 of the coil spring 7.

As shown in FIG. 3(B), a hole 42 in which the vibration insulating member 6 is inserted may be provided in the base member 4, and an vibration insulating member 6b may be inserted to provide in the hole 42 to a position where the vibration insulating member 6b is in contact with one surface of the pressure transmission section 51. In this case, although the vibration insulating member 6b and the pressure transmission section 51 are in contact with each other, the vibration insulating member 6b does not disturb the movement of the pressure transmission section 51 in a rotational direction around the support shaft 9. The vibration insulating member 6b can thereby prevent the resonance due to the vibration of the pressure transmission section 51 in a thickness direction (a vertical direction in FIG. 3(B)).

The oscillation motor according to the present invention may be also applied to a case in which the press mechanism 5 can be arranged in series on the reference line L in addition to the embodiment shown in the drawings. That is, even when the press mechanism 5 is arranged so as to press the oscillator 2 from a direction perpendicular to the other side surface 2b of the oscillator 2 on the other end side, generation of the noise due to the resonance can be avoided by providing the vibration insulating member 6 between the press mechanism 5 and the base member 4 even the oscillator 2 is made vibrate while the oscillation motor 1 is in operation.

Next, the lens driving mechanism according to the present invention will be demonstrated. The lens driving mechanism according to the present invention comprises the above oscillation motor 1 as shown in FIG. 1 as the driving source for making a lens travel in an optical axis direction. Since the lens driving mechanism comprises the oscillation motor 1 according to the present invention as the driving source, the generation of the resonance due to the vibration generated in the oscillator 2 is avoided, and silence in making a lens travel can be made excellent.

Since the oscillation motor according to the present invention avoids the generation of a noise due to the resonance of components, the oscillation motor is excellent in silence. Thus, the oscillation motor can be used as a driving source of a device which requires silence such as a device having a sound collection function in addition to the driving source of the lens driving mechanism for an image pickup device such as a camera.

1. An oscillation motor that makes an oscillator vibrate and transmits the vibration generated in the oscillator as a driving force by bringing the oscillator into pressure-contact with a driven body, comprising:
a base member;
an oscillator provided with a protruding output section on an one side surface on one end side and mounted on the base member wherein the output section is arranged in contact with the driven body; and
a press mechanism that is mounted on the base member and presses the oscillator toward the driven body on the other side surface on an opposite end side of the oscillator,
wherein a vibration insulating member is provided between the base member and the press mechanism.

2. The oscillation motor according to claim 1,
wherein the vibration insulating member is a buffer material selected from the group consisting of a plastic with excellent softness, a silicon-based member, and a rubber-based member.

3. The oscillation motor according to claim 1,
wherein the press mechanism comprises a pressure source and a pressure transmission section that transmits a press force from the pressure source to the oscillator,
the pressure transmission section is mounted on the base member via a support shaft, and
the vibration insulating member is provided between the pressure transmission section and the base member in the vicinity of the pressure source.

4. The oscillation motor according to claim 1,
wherein the press mechanism comprises a pressure source and a pressure transmission section that transmits a press force from the pressure source to the oscillator,
an end portion of the press mechanism at the pressure source is mounted on the base member, and
the vibration insulating member is provided between the end portion of the press mechanism at the pressure source and the base member.

5. A lens driving mechanism comprising an oscillation motor according to claim 1 as a driving source for making a lens travel in an optical axis direction.
